(19) United States
(12) Patent Application Publication
(10) Pub. No.: US 2011/0314009 A1
(43) Pub. Date: Dec. 22, 2011

(54) Method and Device for Extracting Characteristic Relation Circle From Network

(75) Inventors: Gengping Cai, Shenzhen City (CN); Haibin Hu, Shenzhen City (CN)

(73) Assignee: TENCENT TECHNOLOGY (SHENZHEN) COMPANY LIMITED, Shenzhen (CN)

(21) Appl. No.: 13/222,133

(22) Filed: Aug. 31, 2011

Related U.S. Application Data
(63) Continuation of application No. PCT/CN2010/070825, filed on Mar. 2, 2010.

(30) Foreign Application Priority Data
Mar. 10, 2009 (CN) 200910127382.3

(51) Int. Cl. G06F 17/30

(52) U.S. Cl. 707/723; 707/769; 707/E17.005; 707/E17.014

(57) ABSTRACT

Embodiments of the invention provide a method and device for extracting a characteristic relation circle from a network, which relate to compute technologies. The method includes: obtaining user information; specifying characteristics of a characteristic relation circle to be extracted; determining a user set, in which user information of users in the user set matches with specified characteristics, and extracting the determined user set as the characteristic relation circle. The device includes an obtaining module and an extracting module. In the technical solution provided by embodiments of the invention, after extracting a characteristic relation circle from a socialized network, relation chain information of the socialized network may be effectively utilized, and the objectives of effective propagation and accurate searching of information may be achieved.

### FIELD OF THE TECHNOLOGY

The invention relates to computer technologies, and more particularly, to a method and device for extracting a characteristic relation circle from a network.

### BACKGROUND OF THE INVENTION

Network Instant Messenger has become indispensable software tools of users, which is widely used not only in daily entertainment, but also in users' work. At present, functions provided by the network Instant Messenger are more and more, and are improved day by day. Meanwhile, socialized network formed by online users is no longer a relation between single users, but is single-to-multiple or multiple-to-multiple relation. The socialized network, which includes a huge number of users and relation data, is of great value. Meanwhile, the socialized network may achieve the objectives of accurate searching and effective propagation, so as to meet different requirements of users and enterprises.

However, not all the huge number of users and data in the socialized network is focused by users and enterprises. Instead, the focused is a relation circle formed by users with specified characteristics. In the prior art, information focused by searching user or enterprise is website searching functions of Social Network Service (SNS) on the basis of Web2.0. Most SNS websites support to search for users in the socialized network with a key word. Thus, users with specified characteristics in the network may be searched out. However, relations among these users and relation circle formed by these users cannot be demonstrated. Subsequently, the socialized network cannot be understood as a whole. Therefore, relation information of greater value cannot be searched out.

### SUMMARY OF THE INVENTION

In order to extract a characteristic relation circle, to implement effective propagation and accurate searching of information in a socialized network, embodiments of the invention provide a method and device for extracting a characteristic relation circle from a network. The technical solution is as follows.

A method for extracting a characteristic relation circle from a network, including:

obtaining user information;

specifying characteristics of a characteristic relation circle to be extracted, determining a user set, in which user information of users in the user set matches with specified characteristics, and extracting the determined user set as the characteristic relation circle; and

determining an influence value of a user in the characteristic relation circle according to the user information.

A device for extracting a characteristic relation circle from a network, in which the device includes an obtaining module, an extracting module and a computing module;

the obtaining module is configured to obtain user information;

the extracting module is configured to determine a user set, according to specified characteristics of a characteristic relation circle to be extracted and the user information obtained by the obtaining module, in which the user information of users in the user set matches with the specified characteristics, and extract the user set determined as the characteristic relation circle; and

the computing module is configured to determine an influence value of a user in the characteristic relation circle, which is extracted by the extracting module, according to the user information obtained by the obtaining module.

The advantages achieved by the technical solution provided by embodiments of the invention are as follows. Relation chain information in the socialized network may be effectively utilized by extracting the characteristic relation circle from the socialized network, so as to achieve the objectives of effective propagation and accurate searching of information.

### BRIEF DESCRIPTION OF THE DRAWINGS

FIG. 1 is a flowchart illustrating a method for extracting a characteristic relation circle from a socialized network in accordance with the first embodiment of the invention.

FIG. 2 is a schematic diagram illustrating to extract a characteristic relation circle from a socialized network in accordance with the first embodiment of the invention.

FIG. 3 is a schematic diagram illustrating to extract a characteristic relation circle from a socialized network and to compute the influence in accordance with the first embodiment of the invention.

FIG. 4 is a schematic diagram illustrating structure of a device, which is configured to extract a characteristic relation circle from a socialized network in accordance with the second embodiment of the invention.

FIG. 5 is a schematic diagram illustrating structure of a device, which is configured to extract a characteristic relation circle from a socialized network and compute the influence, in accordance with the second embodiment of the invention.

### EMBODIMENTS OF THE INVENTION

To make objectives, technical solutions and advantages of the invention more clear, detailed descriptions about the implementation modes of the invention are further provided in the following, accompanying with attached figures.

### The First Embodiment

With reference to FIG. 1, an embodiment of the invention provides a method for extracting a characteristic relation circle from a socialized network, which includes the following.

Block 101: obtaining user information.

The user information therein may include relation data and characteristic data. The relation data about each user may be extracted from a user profile database, and then may be stored into Table 1, relation circle information table of a socialized network system. The user profile database may store user profile information of an Instant Messaging (IM) platform, or user profile data of an SNS website on the basis of Web 2.0. Each user has a unique identification (ID). To define type for relation between users, relation between each user and other user may be denoted with (ID1, type), . . . , (IDn, type). Other denotation types may also be used.

The relation type in the embodiment of the invention includes, but not limited to, buddy, known, stranger, and so on. If IDs of users A, B, C and D are respectively 10001, 10002, 10003 and 10004, A and B are buddies, A knows C, D is a stranger of A, and then the relation information description of A is (B, buddy), (C, known), (D, stranger).

Characteristic data about each user may also be extracted from the user profile database, and stored into Table 1. The characteristic data describes one attribute or action of a user, the denotation mode thereof may be (type, value). For example, the professional information of user A: (company, XX), (speciality, computer), (profession, programming). Subsequently, the relation information and characteristic data about user A, which is stored in Table 1, is as follows.

TABLE 1
relation circle information table of a socialized network system

| ID | relation data | characteristic data |
|---|---|---|
| 10001 | (10002, buddy), | (company, XX), |
| | (10003, known), | (speciality, computer), |
| | (10004, stranger) | (profession, programming) |
| 10002 | . . . | . . . |

Block 102: characteristics of a characteristic relation circle to be extracted are specified. Users, the user information of which matches with the specified characteristics, are extracted as a characteristic relation circle.

For example, characteristics of the characteristic relation circle may be specified as: (speciality, computer), (profession, programming). And then, characteristic data in the user information about each user in Table 1 may be matched with the specified characteristics. Users with the specified characteristics in Table 1 may be extracted as a characteristic relation circle. Alternatively, the field to which the characteristic relation circle belongs may be specified. And then, the specified characteristics may be obtained according to characteristics corresponding to the field. For example, the field to which the characteristic relation circle belongs is IT industry. The characteristics corresponding to the IT industry may be computer, network, programming, and so on. The characteristics corresponding to the IT industry may be characteristics of the specified characteristic relation circle. Characteristics corresponding to a certain field may be stored in a machine in advance, and then be automatically analyzed by a machine, or may also be set by users.

For example, based on Table 1, it can be seen that the user, whose ID is 10001, matches with the IT circle. And then, the user with ID 10001 may be extracted. Supposing the IT circle may still match with two users, the IDs of which are 10003 and 10004. And then, the two users with IDs 10003 and 10004 may also be extracted. The extracted users may be taken as a characteristic relation circle.

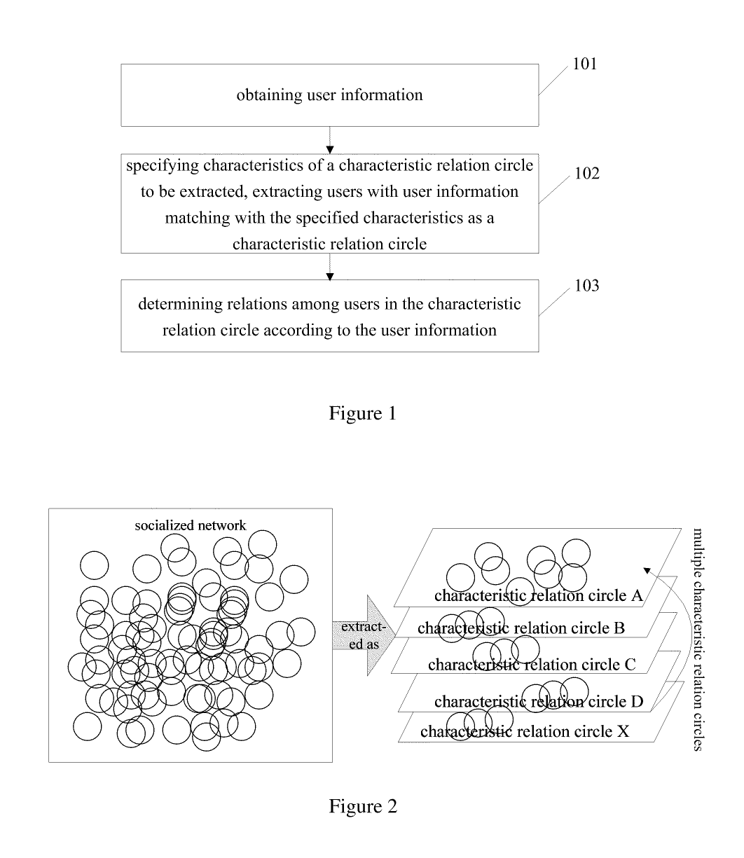

With reference to FIG. 2, a characteristic relation circle may be extracted from a socialized network including a huge number of data. Characteristics of a certain characteristic relation circle may be specified as A. And then, users with characteristics A may be extracted from the socialized network, to be taken as characteristic relation circle A. Similarly, characteristics of another characteristic relation circle may be specified as B. And then, users with characteristics B may be extracted from the socialized network, to be taken as characteristic relation circle B. And the like, multiple characteristic relation circles may be extracted from the socialized network.

Block 103: relations among users in a characteristic relation circle may be determined according to user information.

Specifically, relations among users in a characteristic relation circle may be determined according to relation data in the user information.

Continuing with the above example, based on the relation data in Table 1, it can be seen that in the users of the IT relation circle extracted, the user with ID 10001 knows the user with ID 10003, the user with ID 10001 is a stranger of user with ID 10004. And then, relations among users in the IT relation circle may be added to the IT relation circle, which is shown in Table 2.

TABLE 2
characteristic relation circle

| | | Specified | | |
|---|---|---|---|---|
| relation | Name of | characteristics | Users in a | |
| circle | relation | of a relation | relation | Relations |
| ID | circle | circle | circle | among users |
| 1 | IT | (speciality, | 10001, 10003, | (10001, 10003), |
| | | computer), | 10004 | (10001, 10004) |
| | | (profession, | | |
| | | programming) | | |
| 2 | . . . | . . . | . . . | |

In the embodiment of the invention, if the relation type is only defined as buddy, the default meaning of (user ID1, user ID2) is as follows. The user with ID1 is a buddy of the user with ID2. If the relation type is defined as buddy, known, stranger, the relation denoted by (user ID1, user ID2) may be buddy, known or stranger. Then, the relation between user with ID1 and user with ID2 may be determined according to the relation information in Table 1.

Preferably, the relation between users in the characteristic relation circle may be denoted with (user ID1, user ID2, type). For example, (10001, 10003, buddy) denotes that the user with ID 10001 and the user with ID 10003 are buddies.

To find out the user most influential from the extracted characteristic relation circle, so as to make the transmission of the information more effective and accurate, the method still includes the following.

Influence value of a user in the characteristic relation circle may be computed according to the user information.

The computation about the influence value of a user in a characteristic relation circle according to the user information, includes the following.

The matching degree between characteristic data of a user in the characteristic relation circle and specified characteristics is scored, to obtain characteristic score of the user.

A function for scoring characteristics of a user in a certain characteristic relation circle may be designed as follows.

User ID={analyzing user's characteristic data, adding points according to a scoring rule}.

For example, regarding the characteristic relation circle for playing the game of dungeon fighter, corresponding game credits may be converted according to user information, when the user plays the game of dungeon fighter, such as duration, grade. Thus, the game credits may be taken as score of the characteristic. The characteristic score may be higher accompanying with the longer duration and higher grade. The higher characteristic score demonstrates the higher matching degree, between characteristics of the user and that of the characteristic relation circle. Subsequently, the user's influence may be larger.

Computation about influence value of a user in a characteristic relation circle, according to the user information, includes the following.

Relations among users in the characteristic relation circle may be determined according to relation data. Relation score of the user may also be computed.

A function for scoring relations of a user in a certain characteristic relation circle may be designed as follows.

User ID={regarding each relation of a user, 10 scores are added if the other is buddy, 5 scores are added if the other is known, 1 score is added if the other is a stranger}.

Computation about influence value of a user in a characteristic relation circle according to user information, includes the following.

Matching degree between characteristic data of a user in the characteristic relation circle and specified characteristic is scored, to obtain the characteristic score of the user.

The relation score of the user may be computed, according to relations among users in the characteristic relation circle determined with the relation data.

Influence score of a user may be computed, according to the characteristic score and relation score.

Specifically, the weighted characteristic score and weighted relation score may be added, to obtain the influence score of the user. And then, a sorting may be performed according to the influence score, to find a user most influential in the characteristic relation circle.

For example, a function for scoring influence of a user in a certain characteristic relation circle may be designed as follows.

User ID=characteristic score*f+relation score*(1−f)

F is weight, the default value of which is 0.5. F may be adjusted according to actual requirements.

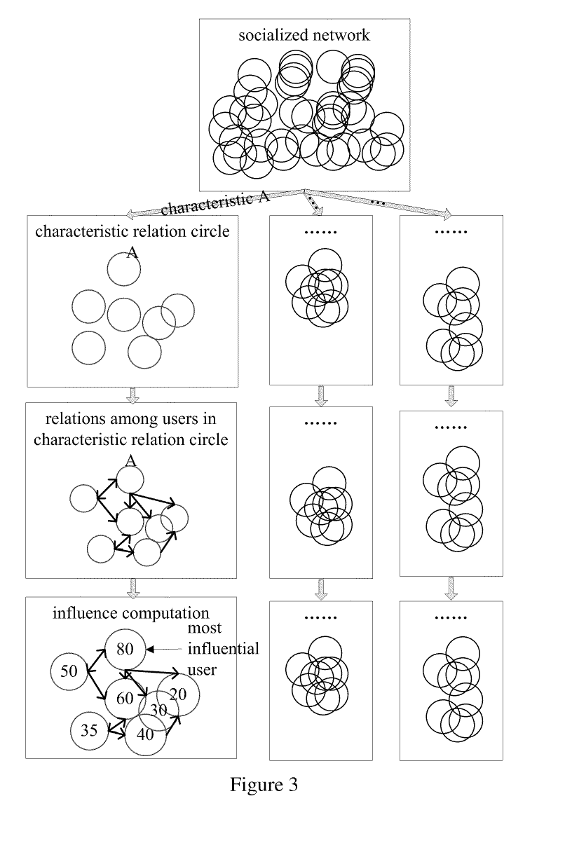

With reference to FIG. 3, a characteristic relation circle may be extracted from a socialized network with a huge number of data. Relations among users in the extracted characteristic relation circle may be determined. And the user most influential therein may be computed.

The advantages achieved by the embodiments of the invention are as follows. After specifying characteristics of a characteristic relation circle to be extracted, the characteristic relation circle may be extracted, according to determined relation data and characteristic data of each user. Influence of users in the characteristic relation circle may be computed, to enable all the users to understand the characteristic relation circle more specifically. Thus, the relation chain information of a socialized network may be effectively utilized, to achieve the objectives of effective propagation and accurate searching.

### The Second Embodiment

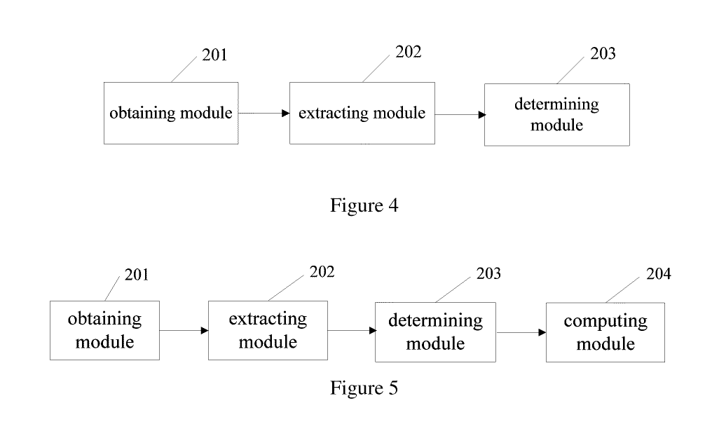

With reference to FIG. 4, the embodiment of the invention provides a device for extracting a relation circle from a socialized network. The device includes: an obtaining module 201, an extracting module 202 and a determining module 203.

The obtaining module 201 is configured to obtain user information, and send obtained user information to the extracting module 202.

The user information may include relation data and characteristic data. The relation data of each user may be extracted from the user profile database, and be stored into the relation circle information table of a socialized network shown in Table 3. The user profile database may store user profile information of an IM platform, or user profile data of SNS website on the basis of Web2.0. Each user has a unique ID. Type of relation between users may be defined. The relation between each user and other user may be denoted with (ID1, type), . . . , (IDn, type). There may also be other denotation modes.

For example, if the relation type is defined as buddy, known and stranger. IDs of users A, B, C and D are respectively 10001, 10002, 10003 and 10004. A and B are buddies. A knows C. A doesn't know D. Subsequently, the relation information descriptions of A are (B, buddy), (C, known), (D, stranger).

The characteristic data of each user may be extracted from the user profile database, and be stored into Table 3. The characteristic data describes a certain attribute or action of a user. Denotation mode of the characteristic data may be (type, value). For example, the professional information of user A: (company, XX), (speciality, computer), (profession, programming). Subsequently, the relation information and characteristic data of user A may be stored into Table 3 as follows.

TABLE 3
relation circle information table of socialized network system

| ID | relation information | characteristic data |
|---|---|---|
| 10001 | (10002, buddy), | (company, XX), |
| | (10003, known), | (speciality, computer), |
| | (10004, stranger) | profession, programming) |
| 10002 | . . . | . . . |

The extracting module 202 is configured to extract users with user information, which matches with specified characteristics, according to the characteristics of specified characteristic relation circle to be extracted, after receiving the user information sent by the obtaining module 201.

For example, characteristics of the characteristic relation circle may be specified as: (speciality, computer), (profession, programming). And then, characteristics data in the user information of each user in Table 1 may be matched with the specified characteristics. Users with the specified characteristics in Table 1 may be extracted as the characteristic relation circle. The field, to which the characteristic relation circle belongs, may also be specified. And then, the specified characteristics may be obtained according to characteristics corresponding to the field. For example, the field to which the specified characteristics relation circle belongs, is IT industry. The characteristics corresponding to the IT industry may be computer, network, programming, and so on. The above characteristics are characteristics in the specified characteristic relation circle. The characteristics corresponding to a certain field may be stored in a machine in advance, which may be automatically analyzed by the machine, or may be set by a user.

For example, based on Table 1, it can be seen that the user with ID 10001 matches with the IT circle. And then, the user with ID 10001 may be extracted. Supposing that two users with IDs 10003 and 10004 still match with the IT circle, users with IDs 10003 and 10004 may also be extracted. All the users extracted may be taken as a characteristic relation circle.

With reference to FIG. 2, a characteristic relation circle may be extracted from a socialized network with a huge number of data. Characteristics of a certain characteristic relation circle may be specified as A. And then, users with characteristics A may be extracted from the socialized network as characteristic relation circle A. Similarly, characteristics of another characteristic relation circle may be specified as B. Subsequently, users with characteristics B may be extracted from the socialized network as characteristic relation circle B. And the like, multiple characteristics relation circles may be extracted from the socialized network.

The determining module 203 is configured to determine relations among users in the characteristic relation circle, which is extracted by the extracting module 202, according to the user information sent by the obtaining module 201.

Continuing with the above example, based on the relation data in Table 3, it can be seen that in the users of the IT relation circle extracted, the user with ID 10001 knows the user with ID 10003. The user with ID 10001 is a stranger of the user with ID 10004. Relations among the users in the IT relation circle are also added into the IT relation circle, which is shown is Table 4.

TABLE 4
characteristic relation circle

| | Name of | Specified | | |
|---|---|---|---|---|
| relation | the | characteristics | Users in the | Relations |
| circle | relation | of the relation | relation | among the |
| ID | circle | circle | circle | users |
| 1 | IT | (speciality, | 10001, 10003, | (10001, 10003), |
| | | computer), | 10004 | (10001, 10004) |
| | | (profession, | | |
| | | programming) | | |
| 2 | . . . | . . . | . . . | |

Relation type in the embodiment of the invention includes, but not limited to, buddy, known, stranger, etc. If the relation type is only defined as buddy, the default meaning of (user ID1, user ID2) is as follows. User with ID1 and user with ID2 are buddies. If the relation type is defined as buddy, known, stranger, (user ID1, user ID2) denotes that the relation between user with ID1 and user with ID2 may be buddy, known, or stranger. And then, the relation between user with ID1 and user with ID2 may be determined according to the relation information shown in Table 3.

Preferably, the relation between users in the characteristic relation circle may be denoted with (user ID1, user ID2, type). For example, (10001, 10003, buddy) denotes that the user with ID 10001 and user with ID 10003 are buddies.

With reference to FIG. 5, the device still includes a computing module 204.

The computing module 204 is configured to compute influence value of a user in the characteristic relation circle, which is extracted by the extracting module 202, according to the user information obtained by the obtaining module 201.

The computing module 204 is specifically configured to score the matching degree between characteristic data of a user in the characteristic relation circle, which is extracted by the extracting module 202, and the specified characteristics, to obtain the characteristic score of the user.

The function for scoring characteristics of a user in a certain characteristic relation circle may be designed as follows.

User ID={analyzing characteristic data of a user, adding score according to a scoring rule}

For example, regarding the characteristic relation circle for playing the game of dungeon fighter, corresponding game credits may be converted according to information about the user, when the user plays the game of dungeon fighter, such as duration, grade. Thus, the game credits may be taken as score of the characteristic. The score may be higher accompanying with the longer duration and higher grade. The higher characteristic score demonstrates the higher matching degree, between characteristics of the user and that of the characteristic relation circle. Subsequently, the user's influence may be higher.

Alternatively, the computing module 204 is specifically configured to compute relation score for a user, according to the relation between users in the characteristic relation circle, which is determined by the determining module 203 based on the relation data.

The function for scoring relation between users in a certain characteristic relation circle may be designed as follows.

User ID={regarding each relation for a user, 10 scores are added if the other is a buddy, 5 scores are added if the other is known, 1 score is added if the other is a stranger}. The larger relation score demonstrates the closer relation between the user and other users in the characteristic relation circle. Subsequently, the influence of the user may be larger.

Alternatively, the computing module 204 includes a first computing unit and a second computing unit.

The first computing unit is configured to compute characteristic score for a user in a characteristic relation circle, which is extracted by the extracting module 202, according to the characteristic data in the user information obtained by the obtaining module 201. The first computing unit is further configured to compute the relation score, according to the relation between users determined by the determining module 203 based on the relation data.

The second computing unit is configured to compute influence score for a user in a characteristic relation circle, which is extracted by the extracting module 202, according to the characteristic score and relation score both computed by the first computing unit.

Specifically, the weighted characteristic score and weighted relation score may be added, to obtain the influence score of each user. And then, a sorting may be performed according to the influence score, to find the most influential user.

For example, the function for scoring influence of a user in a certain characteristic relation circle may be designed as follows.

User ID=characteristic score*f+relation score*(1−f)

F is weight, the default value of which is 0.5. F may be adjusted according to actual requirements.

With reference to FIG. 3, a characteristic relation circle may be extracted from a socialized network with a huge number of data. Relation between users in the characteristic relation circle extracted may be determined. The user most influential may be computed.

The advantages achieved by the embodiments of the invention are as follows. After specifying characteristics of a characteristic relation circle to be extracted, a characteristic relation circle may be extracted, according to the determined relation data and characteristic data of each user. Influence of users in the characteristic relation circle may be computed, to enable all the users to understand the characteristic relation circle deeply, so as to effectively utilize the relation chain information of the socialized network, and to achieve the objectives of effective propagation and accurate searching of information.

The foregoing is only preferred embodiments of the invention, which is not used for limiting the invention. Any modifications, equivalent substitutions and improvements within the spirit and principle of the invention, should be covered by the protection scope of the invention.

1. A method for extracting a characteristic relation circle from a network, comprising:
obtaining user information;
specifying characteristics of a characteristic relation circle to be extracted, determining a user set, wherein user information of users in the user set matches with specified characteristics, and extracting the determined user set as the characteristic relation circle; and
determining an influence value of a user in the characteristic relation circle according to the user information.

2. The method according to claim 1, wherein the characteristics of the characteristic relation circle to be extracted comprise:
characteristics corresponding to a field of the characteristic relation circle to be extracted.

3. The method according to claim 1, wherein the user information comprises characteristic data, and determining the influence value of the user in the characteristic relation circle according to the user information comprises:
scoring matching degree between the characteristic data of the user in the characteristic relation circle and the specified characteristics, to obtain characteristic score of the user, and
determining the influence value of the user in the characteristic relation circle according to the characteristic score.

4. The method according to claim 1, wherein the user information comprises relation data, and determining the influence value of the user in the characteristic relation circle according to the user information comprises:
computing relation score for the user, according to relation between users in the characteristic relation circle determined based on the relation data, and determining the influence value of the user in the characteristic relation circle according to the relation score.

5. The method according to claim 1, wherein the user information comprises characteristic data and relation data, and determining the influence value of the user in the characteristic relation circle according to the user information comprises:
scoring matching degree between the characteristic data of the user in the characteristic relation circle and the specified characteristics, to obtain characteristic score of the user;
computing relation score for the user, according to the relation between users in the characteristic relation circle, which is determined based on the relation data;
adding the weighted characteristic score and the weighted relation score; and
determining weighted result as the influence value of the corresponding user in the characteristic relation circle.

6. The method according to claim 1, before determining the influence value of the user in the characteristic relation circle, the method further comprising:
determining relation between users in the characteristic relation circle according to the user information.

7. The method according to claim 2, before determining the influence value of the user in the characteristic relation circle, the method further comprising:
determining relation between users in the characteristic relation circle according to the user information.

8. The method according to claim 3, before determining the influence value of the user in the characteristic relation circle, the method further comprising:
determining relation between users in the characteristic relation circle according to the user information.

9. The method according to claim 4, before determining the influence value of the user in the characteristic relation circle, the method further comprising:
determining relation between users in the characteristic relation circle according to the user information.

10. The method according to claim 5, before determining the influence value of the user in the characteristic relation circle, the method further comprising:
determining relation between users in the characteristic relation circle according to the user information.

11. A device for extracting a characteristic relation circle from a network, wherein the device comprises an obtaining module, an extracting module and a computing module;
the obtaining module is configured to obtain user information;
the extracting module is configured to determine a user set, according to specified characteristics of a characteristic relation circle to be extracted and the user information obtained by the obtaining module, in which the user information of users in the user set matches with the specified characteristics, and extract the user set determined as the characteristic relation circle; and
the computing module is configured to determine an influence value of a user in the characteristic relation circle, which is extracted by the extracting module, according to the user information obtained by the obtaining module.

12. The device according to claim 11, wherein the user information comprises characteristic data, and
the computing module is further configured to score matching degree between the characteristic data of a user in the characteristic relation circle and the specified characteristics, to obtain characteristic score of the user, and determine influence value of the user in the characteristic relation circle according to the characteristic score, in which the characteristic relation circle is extracted by the extracting module.

13. The device according to claim 11, wherein the user information comprises relation data, and
the computing module is further configured to compute relation score for a user, according to relation between users in the characteristic relation circle, and determine influence value of the user in the characteristic relation circle according to the relation score.

14. The device according to claim 11, wherein the user information comprises characteristic data and relation data, and the computing module further comprises a first computing unit and a second computing unit;
the first computing unit is configured to score matching degree between the characteristic data of a user in the characteristic relation circle and the specified characteristics, to obtain characteristic score of the user, in which the characteristic relation circle is extracted by the extracting module, to compute relation score for the user, according to the relation between users in the characteristic relation circle; and
the second computing unit is configured to add weighted characteristic score to weighted relation score, to determine weighted result as influence value of a corresponding user in the characteristic relation circle, in which the characteristic score and the relation score are both obtained after computing by the first computing unit.

15. The device according to claim 11, wherein the device further comprises a determining module; and
the determining module is configured to determine relation between users in the characteristic relation circle, which is extracted by the extracting module, according to the user information obtained by the obtaining module.

16. The device according to claim 12, wherein the device further comprises a determining module; and
the determining module is configured to determine relation between users in the characteristic relation circle, which is extracted by the extracting module, according to the user information obtained by the obtaining module.

17. The device according to claim 13, wherein the device further comprises a determining module; and
the determining module is configured to determine relation between users in the characteristic relation circle, which is extracted by the extracting module, according to the user information obtained by the obtaining module.

18. The device according to claim 14, wherein the device further comprises a determining module; and
the determining module is configured to determine relation between users in the characteristic relation circle, which is extracted by the extracting module, according to the user information obtained by the obtaining module.
